(19) United States
(12) Patent Application Publication
(10) Pub. No.: US 2013/0083095 A1
(43) Pub. Date: Apr. 4, 2013

(54) DISPLAY DEVICE AND METHOD FOR DISPLAYING 3D IMAGES THEREOF

(71) Applicants: Wei-Chen Chueh, Hsin-Chu (TW); Jung-Ching Chen, Hsin-Chu (TW)

(72) Inventors: Wei-Chen Chueh, Hsin-Chu (TW); Jung-Ching Chen, Hsin-Chu (TW)

(21) Appl. No.: 13/456,200

(22) Filed: Apr. 25, 2012

(30) Foreign Application Priority Data
Sep. 30, 2011 (TW) 100135650

(51) Int. Cl. G09G 3/36; G09G 5/10

(52) U.S. Cl. 345/691; 345/102

(57) ABSTRACT

A method for displaying 3D images of a display device is disclosed. The display device includes a display panel and a backlight module. The method includes determining a first turn-on time length of the backlight module according to a gray level of at least a pixel of a first frame; when the display panel displays the first frame, turning on the backlight module for the first turn-on time length; determining a second turn-on time length of the backlight module according to a gray level of at least a pixel of a second frame; and when the display panel displays the second frame, turning on the backlight module for the second turn-on time length. The method for displaying 3D images can reduce crosstalk effect of the display device.

### BACKGROUND OF THE INVENTION

1. Field of the Invention

The present invention relates to a method for displaying 3D images of a display device, and more particularly, to a method for displaying 3D images of a display device capable of reducing crosstalk effect.

2. Description of the Prior Art

Please refer to FIG. 1. FIG. 1 is a diagram illustrating a method for displaying 3D images of the prior art. In order to display 3D images, a display panel displays a left eye image L and a right eye image R sequentially, and a left eye and a right eye of a user can see the left eye image L and the right eye image R respectively through a pair of shutter glasses, which further forms a 3D image visually. For example, a first frame displayed by the display panel is a left eye image L1, a second frame displayed by the display panel is a right eye image R1, a third frame displayed by the display panel is a left eye image L2, a fourth frame displayed by the display panel is a right eye image R2, and so on.

In addition, if the left eye sees the right eye image R partially and the right eye sees the left eye image L partially, a crosstalk effect arises. That is, one object has two image edges. As shown in FIG. 1, in order to prevent the crosstalk effect, the method for displaying 3D images of the prior art controls a turn-on time length of a backlight module of a display device, such that the backlight module is only turned on for a predetermined time length T in a display period of a frame, and the backlight module is turned off in the other time of the display period. However, a tilted angle of liquid crystals of the display panel is determined according to a gray level value of the image, and a tilted speed of the liquid crystal is limited. When a brighter image (i.e. the gray level value is 255) is displayed in a display period of the first frame L1, and a darker image (i.e. the gray level value is 0) is displayed in a display period of the second frame R1, liquid crystals of a pixel are still tilting during the display period of the second frame (a tilted level is changed from LV4 to LV0). If the backlight module is turned on when the liquid crystal is still tilting, a user will see part of the left eye image to further form a residual image visually, which is a so called crosstalk effect. A level of the crosstalk effect can be determined according to the below equation:

C=(WE−BB)÷(WW−BB) (1)

where C is the level of the crosstalk effect, WB is a measured brightness value of an image when the liquid crystals are tilted from a tilted level LV4 in a highest brightness (i.e. the gray level value is 255) to a tilted level LV0 in a lowest brightness (i.e. the gray level value is 0), WW is a measured brightness value of an image in the highest brightness, and BB is a measured brightness value of an image in the lowest brightness.

According to the above equation, if the turn-on time length of the backlight module in a display period of a frame is longer, the level of the crosstalk effect is higher. If the turn-on time length of the backlight module in the display period of the frame is shorter, the level of the crosstalk effect is lower, but brightness of the image displayed by the display panel is also reduced, such that the whole image of the display panel becomes darker. The method for displaying 3D images of the prior art can not reduce the level of the crosstalk effect while keeping the brightness of the whole image of the display panel at the same time.

### SUMMARY

The present invention relates to a method for displaying 3D images of a display device. The display device includes a display panel and a backlight module. The method includes determining a first turn-on time length of the backlight module according to a gray level value of at least a pixel of a first frame; when the display panel displays the first frame, turning on the backlight module for the first turn-on time length; determining a second turn-on time length of the backlight module according to a gray level value of at least a pixel of a second frame; and when the display panel displays the second frame, turning on the backlight module for the second turn-on time length. Wherein, if the gray level value of at least a pixel of the first frame is not equal to the gray level value of at least a pixel of the second frame, the first turn-on time length is not equal to the second turn-on time length.

The present invention further relates to a display device. The display device includes a display panel, a backlight module, and a control unit. The display panel comprises a plurality of pixels for displaying images. The backlight module is arranged at one side of the display panel for generating light. The control unit is electrically connected to the display panel and the backlight module. The control unit is for determining a first turn-on time length of the backlight module according to a gray level value of at least a pixel of a first frame and turning on the backlight module for the first turn-on time length when the display panel displays the first frame, and for determining a second turn-on time length of the backlight module according to a gray level value of at least a pixel of a second frame and turning on the backlight module for the second turn-on time length when the display panel displays the second frame. If the gray level value of at least a pixel of the first frame is not equal to the gray level of at least a pixel of the second frame, the first turn-on time length is not equal to the second turn-on time length.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a method for displaying 3D images of the prior art.

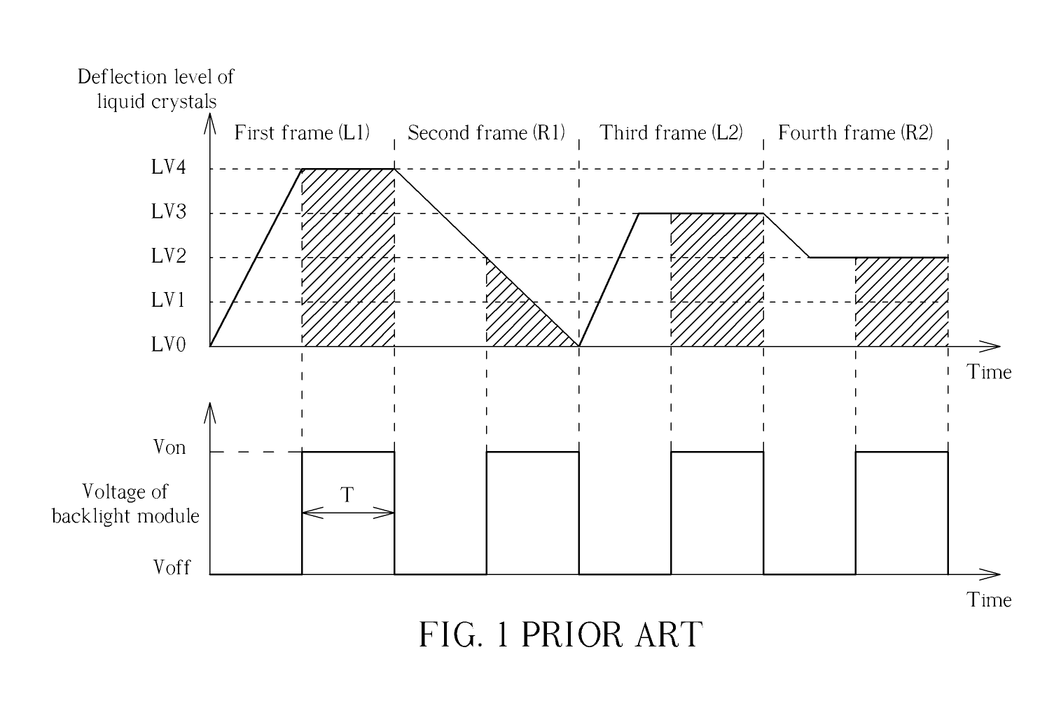

FIG. 2 is a diagram showing a display device of the present invention.

FIG. 3 is a diagram illustrating a method for displaying 3D images of the present invention.

FIG. 4 is a diagram showing a look-up table of the present invention.

FIG. 5 is a diagram illustrating a method for displaying 3D images of the present invention further determining turn-on voltages of the backlight module according to gray level values of pixels of a frame.

FIG. 6 is a diagram showing another display device of the present invention.

FIG. 7 is a flowchart showing a method for displaying 3D images of the present invention.

### DETAILED DESCRIPTION

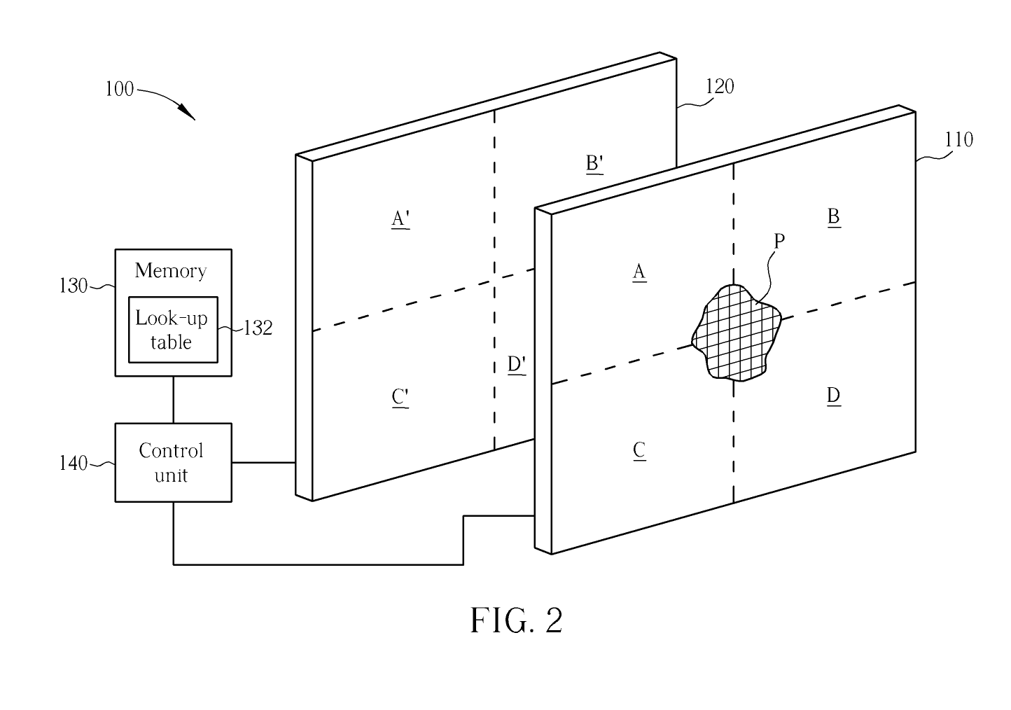

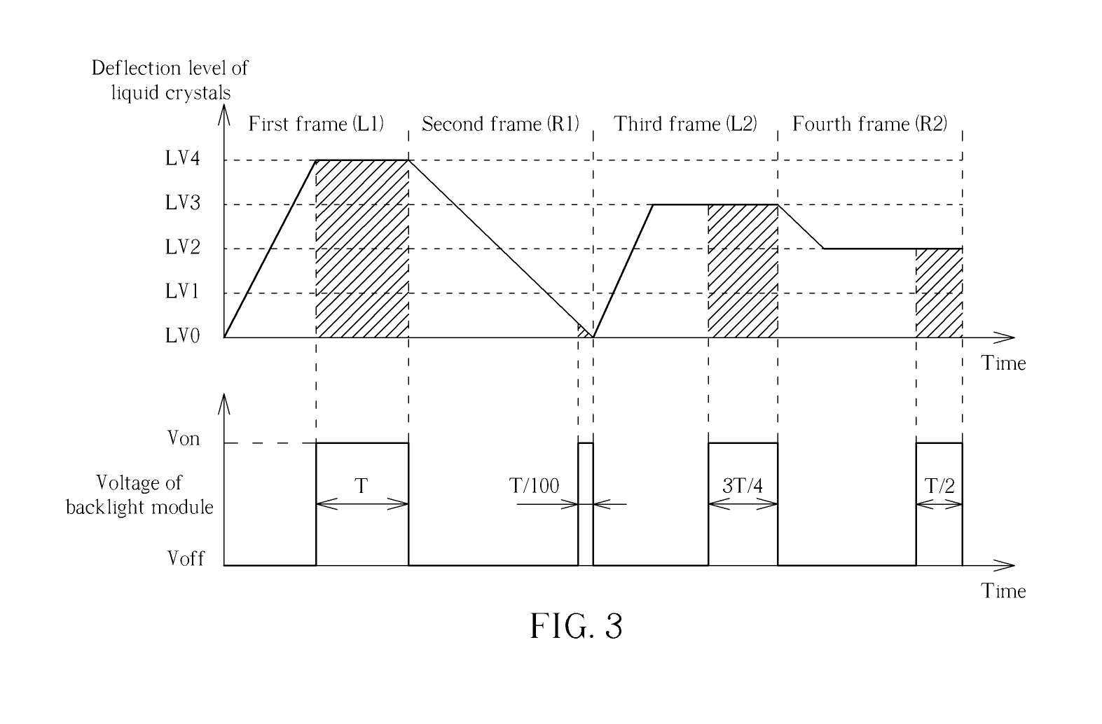

Please refer to FIG. 2. FIG. 2 is a diagram showing a display device according to one embodiment of the present invention. The display device 100 of the embodiment comprises a display panel 110, a backlight module 120, a memory 130, and a control unit 140. The display panel 110 comprises a plurality of pixels P, and the display panel 110 displays left eye images and right eye images sequentially. The backlight module 120 is arranged at one side of the display panel 110. The backlight module 120 can be a direct-lighting backlight module or an edge-lighting backlight module. The control unit 140 is electrically connected to the display panel 110 and the backlight module 120. In order to reduce a level of crosstalk effect while maintaining brightness of a whole image of the display panel at the same time, the control unit 140 dynamically adjusts a turn-on time length of the backlight module 120 according to a gray level value of the pixels P of each frame. Please refer to FIG. 3. FIG. 3 is a diagram illustrating a method for displaying 3D images of the present invention. As shown in FIG. 3, the display panel displays a left viewing image L1 as a first frame, a right viewing image R1 as a second frame, a left viewing image L2 as a third frame, a right viewing image R2 as a fourth frame, and so on. Taking an 8-bit display panel for example, when the display panel 110 displays the first frame and a gray level value of at least a pixel of the first frame is 255, the control unit 140 turns on the backlight module 120 for a predetermined time length T during a display period of the first frame. When the display panel 110 displays the second frame and a gray level value of at least a pixel of the second frame is 0, the control unit 140 turns on the backlight module 120 for a time length of T/100 during a display period of the second frame. When the display panel 110 displays the third frame and a gray level value of at least a pixel of the third frame is 192, the control unit 140 turns on the backlight module 120 for a time length of 3T/4 during a display period of the third frame. When the display panel 110 displays the fourth frame and a gray level value of at least a pixel of the fourth frame is 128, the control unit 140 turns on the backlight module 120 for a time length of T/2 during a display period of the fourth frame.

According to the above arrangement, when liquid crystals of the pixel P are tilted from a tilted level LV4 at highest brightness (the gray level value is 255) to a tilted level LV0 at lowest brightness (the gray level value is 0), the control unit 140 only turns on the backlight module 120 for the time length of T/100. Therefore, image brightness of the second frame is reduced. According to the equation (1), the level of crosstalk effect is reduced accordingly. When the display panel 110 displays a brighter image, the control unit 140 turns on the backlight module 120 for a longer time length, so as to prevent the brighter image from becoming dark.

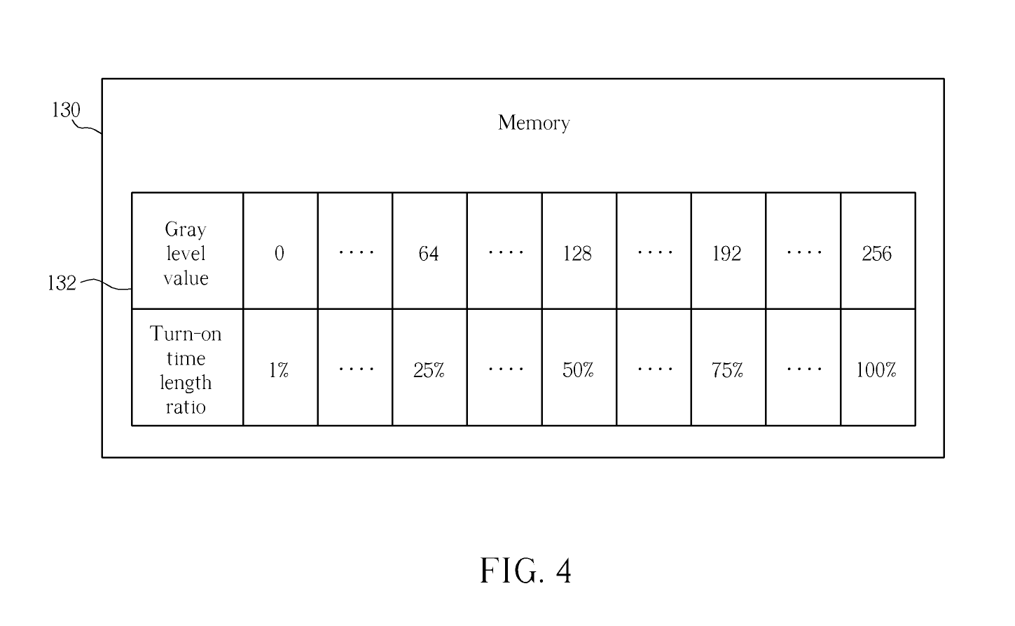

The turn-on time length of the backlight module 120 is determined by the control unit 140 according to a gray level value of at least a pixel P of a frame and a predetermined ratio, or according to the gray level value of at least a pixel P of the frame and a look-up table 132 stored in the memory 130. Please refer to FIG. 4. FIG. 4 is a diagram showing a look-up table of the present invention. As shown in FIG. 4, the look-up table stores correlation information between a plurality of gray level values and turn-on time length ratios of the backlight module 120. For example, when the gray level value is 225, the turn-on time length ratio of the backlight module 120 is 100%; when the gray level value is 192, the turn-on time length ratio of the backlight module 120 is 75%; when the gray level value is 128, the turn-on time length ratio of the backlight module 120 is 50%; when the gray level value is 64, the turn-on time length ratio of the backlight module 120 is 25%; and when the gray level value is 0, the turn-on time length ratio of the backlight module 120 is 1%.

In addition, the control unit 140 can also determine the turn-on time length of the backlight module 120 according to an average gray level value of the plurality of pixels P of the frame (or gray level values of the plurality of pixels P and a corresponding weight value of the pixels).

Moreover, the control unit 140 can further divide the display panel 110 into a plurality of display blocks. The control unit 140 further determines a turn-on time length of a light source of the backlight module 120 corresponding to the display block according to a gray level value of pixels of the display block. For example, the control unit 140 can divide the display panel 110 into four display blocks A, B, C, D. When the display panel 110 displays the first frame, and if an average gray level value of a plurality of pixels P of the display block A of the first frame is 255, an average gray level value of a plurality of pixels P of the display block B of the first frame is 0, an average gray level value of a plurality of pixels P of the display block C of the first frame is 128, and an average gray level value of a plurality of pixels P of the display block D of the first frame is 192, the control unit 140 turns on a light source A′ of the backlight module 120 corresponding to the display block A for a predetermined time length T, turns on a light source B′ of the backlight module 120 corresponding to the display block B for a time length T/100, turns on a light source C′ of the backlight module 120 corresponding to the display block C for a time length T/2, and turns on a light source D′ of the backlight module 120 corresponding to the display block D for a time length 3T/4 during the display period of the first frame. When the display panel 110 displays the second frame, the control unit 140 further determines the turn-on time lengths of the light sources A′, B′, C′, D′ of the backlight module 120 corresponding to each display block A, B, C, D according to gray level values of pixels of each display block A, B, C, D of the second frame respectively. In other words, during the display periods of different frames, the turn-on time length of the light source corresponding to each display block is controlled independently.

Besides the control unit 140 illustrated above determining the turn-on time lengths of the light sources corresponding to the plurality of display blocks according to the average gray level values of the plurality of pixels P of the display blocks, the control unit 140 can also determine the turn-on time lengths of the light sources corresponding to the plurality of display blocks according to the gray level values of the plurality of pixels P of the display blocks and a corresponding weight value of the pixels.

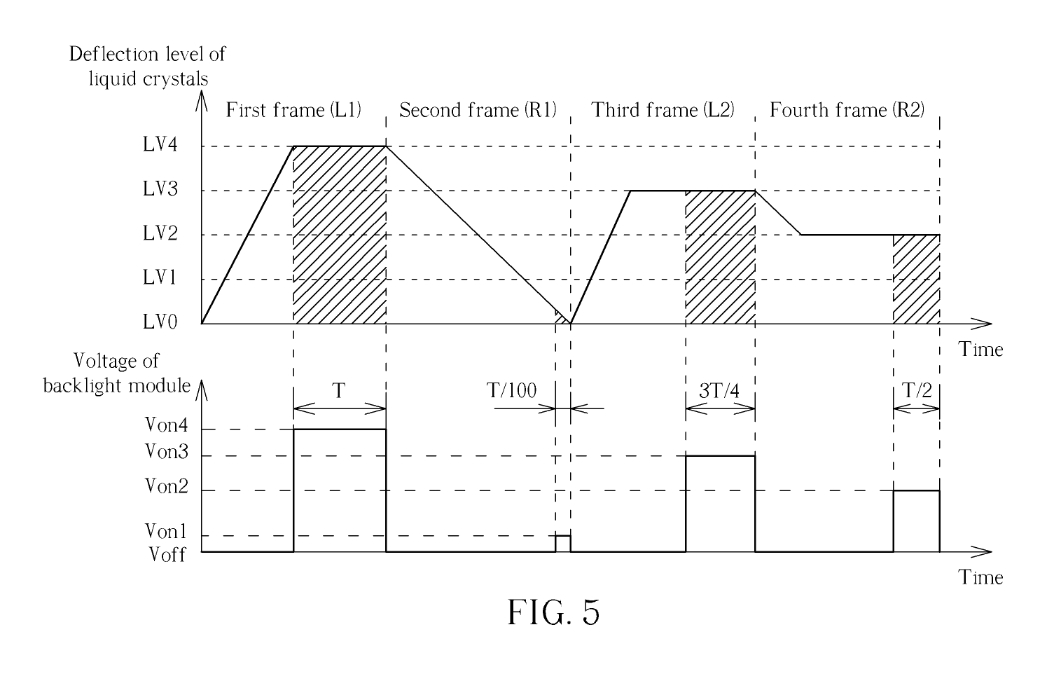

Please refer to FIG. 5. FIG. 5 is a diagram illustrating a method for displaying 3D images of the present invention further determining turn-on voltages of the backlight module according to gray level values of pixels of a frame. As shown in FIG. 5, the control unit 140 determines turn-on voltages of the backlight module 120 according to the gray level values of the pixels of the frames, where the brightness of the backlight module 120 is determined accordingly. Taking an 8-bit display panel for example, when the display panel 110 displays the first frame and the gray level value of at least a pixel of the first frame is 255, the control unit 140 turns on the backlight module 120 for the predetermined time length T with a turn-on voltage Von4 during the display period of the first frame. When the display panel 110 displays the second frame and the gray level value of at least a pixel of the second frame is 0, the control unit 140 turns on the backlight module 120 for the time length T/100 with a turn-on voltage Von1 during the display period of the second frame. When the display panel 110 displays the third frame and the gray level value of at least a pixel of the third frame is 192, the control unit 140 turns on the backlight module 120 for the time length 3T/4 with a turn-on voltage Von3 during the display period of the third frame. When the display panel 110 displays the fourth frame and the gray level value of at least a pixel of the fourth frame is 128, the control unit 140 turns on the backlight module 120 for the time length T/2 with a turn-on voltage Von2 during the display period of the fourth frame, where Von4>Von3>Von2>Von1>Voff. In other words, when the gray level values of the pixels of the frame are larger (such as the first frame), the control unit 140 turns on the backlight module 120 for a longer time length with a larger voltage (higher brightness); when the gray level values of the pixels of the frame are smaller (such as the second frame), the control unit 140 turns on the backlight module 120 for a shorter time length with a lower voltage (lower brightness). Therefore, the level of the crosstalk effect can be reduced.

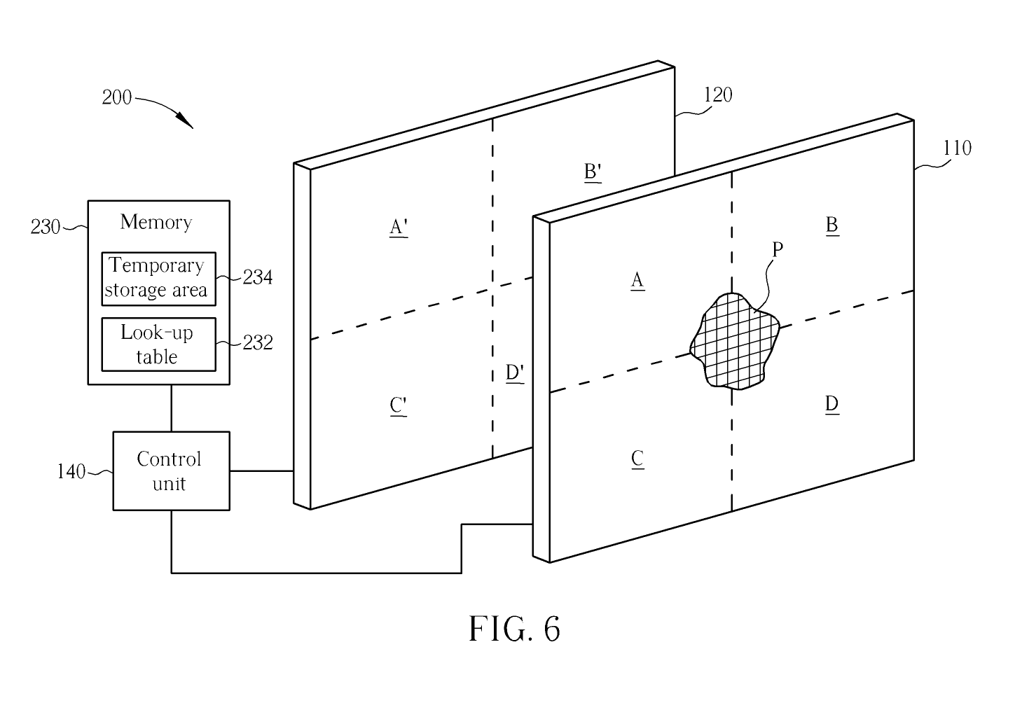

Please refer to FIG. 6. FIG. 6 is a diagram showing another display device 200 of the present invention. As shown in FIG. 6, a memory 230 of the display device 200 further comprises a temporary storage area 234 for storing information of turn-on time lengths or turn-on voltages of the backlight module 120 corresponding to each frame. When a data size of a frame of the display device 200 is large, the control unit 140 can compute the turn-on time length or the turn-on voltage of the backlight module corresponding to an un-displayed frame in advance, and store the information of the turn-on time length or the turn-on voltage in the temporary storage area 234. When the un-displayed frame is going to be displayed in a period of time later, the control unit 140 controls the backlight module 120 according to the information of the turn-on time length or the turn-on voltage of the backlight module stored in the temporary storage area 234.

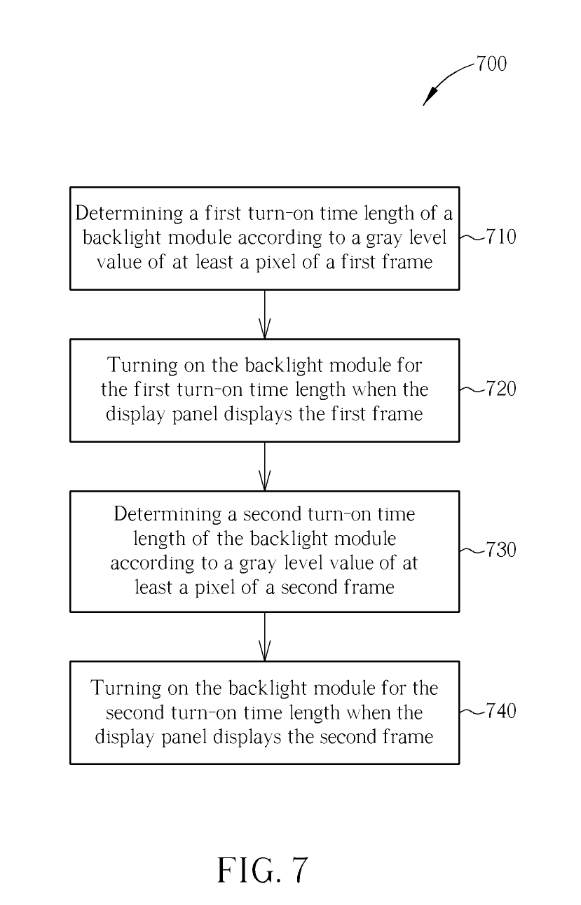

Please refer to FIG. 7. FIG. 7 is a flowchart 700 showing the method for displaying 3D images of the present invention. The flowchart of the method for displaying 3D images of the present invention comprises the following steps:

Step 710: Determining a first turn-on time length of a backlight module according to a gray level value of at least a pixel of a first frame;

Step 720: Turning on the backlight module for the first turn-on time length when the display panel displays the first frame;

Step 730: Determining a second turn-on time length of the backlight module according to a gray level value of at least a pixel of a second frame; and

Step 740: Turning on the backlight module for the second turn-on time length when the display panel displays the second frame.

Basically, the steps of the flowchart 700 need not be in the exact order shown and need not be contiguous, that is, other steps can be inserted between.

In contrast to the prior art, when displaying the left viewing images and the right viewing images sequentially, the display device of the present invention dynamically adjusts the turn-on time length of the backlight module according to the gray level values of the pixels of each frame, such that not only the level of the crosstalk effect is reduced, but also the brightness of the whole image of the display panel is kept.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for displaying 3D images of a display device, the display device comprising a display panel and a backlight module, the method comprising:
determining a first turn-on time length of the backlight module according to a gray level value of at least a pixel of a first frame;
turning on the backlight module for the first turn-on time length when the display panel displays the first frame;
determining a second turn-on time length of the backlight module according to a gray level value of at least a pixel of a second frame;
turning on the backlight module for the second turn-on time length when the display panel displays the second frame;
providing a left eye image in the first frame; and
providing a right eye image in the second frame;
wherein when the gray level value of at least a pixel of the first frame is different to the gray level value of at least a pixel of the second frame, the first turn-on time length is different to the second turn-on time length.

2. The method of claim 1, wherein determining the first turn-on time length of the backlight module according to the gray level value of at least a pixel of the first frame is determining the first turn-on time length of the backlight module according to the gray level value of at least a pixel of the first frame and a look-up table; wherein determining the second turn-on time length of the backlight module according to the gray level value of at least a pixel of the second frame is determining the second turn-on time length of the backlight module according to the gray level value of at least a pixel of the second frame and the look-up table.

3. The method of claim 1, wherein determining the first turn-on time length of the backlight module according to the gray level value of at least a pixel of the first frame is determining the first turn-on time length of the backlight module according to an average gray level value of a plurality of pixels of the first frame; wherein determining the second turn-on time length of the backlight module according to the gray level value of at least a pixel of the second frame is determining the second turn-on time length of the backlight module according to an average gray level value of a plurality of pixels of the second frame.

4. The method of claim 1, wherein determining the first turn-on time length of the backlight module according to the gray level value of at least a pixel of the first frame is determining the first turn-on time length of the backlight module according to gray level values of a plurality of pixels of the first frame and a weight value of the plurality of pixels; wherein determining the second turn-on time length of the backlight module according to the gray level value of at least a pixel of the second frame is determining the second turn-on time length of the backlight module according to gray level values of the plurality of pixels of the second frame and a weight value of plurality of the pixels.

5. The method of claim 1, further comprising:
determining a first turn-on voltage of the backlight module according to the gray level value of at least a pixel of the first frame; and
determining a second turn-on voltage of the backlight module according to the gray level value of at least a pixel of the second frame;
wherein if the gray level value of at least a pixel of the first frame is not equal to the gray level value of at least a pixel of the second frame, the first turn-on voltage is not equal to the second turn-on voltage.

6. The method of claim 1, wherein determining the first turn-on time length of the backlight module according to the gray level value of at least a pixel of the first frame is determining the first turn-on time length according to a gray level value of at least a pixel of a first display block of a plurality of display blocks of the first frame;
wherein turning on the backlight module for the first turn-on time length when the display panel displays the first frame is turning on a light source of the backlight module corresponding to the first display block for the first turn-on time length when the display panel displays the first frame;
wherein determining the second turn-on time length of the backlight module according to the gray level value of at least a pixel of the second frame is determining the second turn-on time length according to a gray level value of at least a pixel of a second display block of a plurality of display blocks of the second frame; and
wherein turning on the backlight module for the second turn-on time length when the display panel displays the second frame is turning on a light source of the backlight module corresponding to the second display block for the second turn-on time length when the display panel displays the second frame.

7. The method of claim 6, wherein a turn-on time length of a light source corresponding to each display block of a plurality of display blocks of a single frame is determined according to a gray level value of at least a pixel of each display block independently.

8. The method of claim 6, wherein determining the first turn-on time length according to the gray level value of at least a pixel of the first display block is determining the first turn-on time length according to the gray level value of at least a pixel of the first display block and a look-up table; wherein determining the second turn-on time length according to the gray level value of at least a pixel of the second display block is determining the second turn-on time length according to the gray level value of at least a pixel of the second display block and the look-up table.

9. The method of claim 6, wherein determining the first turn-on time length according to the gray level value of at least a pixel of the first display block is determining the first turn-on time length according to an average gray level value of a plurality of pixels of the first display block; wherein determining the second turn-on time length according to the gray level value of at least a pixel of the second display block is determining the second turn-on time length according to an average gray level value of a plurality of pixels of the second display block.

10. The method of claim 6, wherein determining the first turn-on time length according to the gray level value of at least a pixel of the first display block is determining the first turn-on time length according to gray level values of a plurality of pixels of the first display block and a weight value of the pixels; wherein determining the second turn-on time length according to the gray level value of at least a pixel of the second display block is determining the second turn-on time length according to gray level values of the plurality of pixels of the second display block and a weight value of the pixels.

11. The method of claim 6, further comprising:
determining a first turn-on voltage of the light source of the backlight module corresponding to the first display block according to the gray level value of at least a pixel of the first display block of the first frame; and
determining a second turn-on voltage of the light source of the backlight module corresponding to the second display block according to the gray level value of at least a pixel of the second display block of the second frame;
wherein if the gray level value of at least a pixel of the first display block of the first frame is not equal to the gray level value of at least a pixel of the second display block of the second frame, the first turn-on voltage is not equal to the second turn-on voltage.

12. A display device comprising:
a display panel, comprising a plurality of pixels for displaying images;
a backlight module, arranged atone side of the display panel for generating light; and
a control unit, electrically connected to the display panel and the backlight module, for determining a first turn-on time length of the backlight module according to a gray level value of at least a pixel of a first frame and turning on the backlight module for the first turn-on time length when the display panel displays the first frame, and for determining a second turn-on time length of the backlight module according to a gray level value of at least a pixel of a second frame and turning on the backlight module for the second turn-on time length when the display panel displays the second frame;
wherein when the gray level value of at least a pixel of the first frame is different to the gray level value of at least a pixel of the second frame, the first turn-on time length is different to the second turn-on time length and a left eye image is provided in the first frame, a right eye image is provided in the second frame.

13. The display device of claim 12, further comprising a memory for storing a look-up table, wherein the control unit is for determining the first turn-on time length of the backlight module according to the gray level value of at least a pixel of the first frame and the look-up table, and for determining the second turn-on time length of the backlight module according to the gray level value of at least a pixel of the second frame and the look-up table.

14. The display device of claim 12, further comprising a memory for storing information of a turn-on time length or a turn-on voltage of a backlight module corresponding to each frame, wherein each frame is delayed to display after the corresponding turn-on time length of the backlight module is determined.

15. The display device of claim 12, wherein the control unit is for determining the first turn-on time length according to a gray level value of at least a pixel of a first display block of a plurality of display blocks of the first frame and turning on a light source of the backlight module corresponding to the first display block for the first turn-on time length when the display panel displays the first frame, and for determining the second turn-on time length according to a gray level value of at least a pixel of a second display block of a plurality of display blocks of the second frame and turning on alight source of the backlight module corresponding to the second display block for the second turn-on time length when the display panel displays the second frame; wherein if the gray level value of at least a pixel of the first display block is not equal to the gray level value of at least a pixel of the second display block, the first turn-on time length is not equal to the second turn-on time length.

16. The display device of claim 15, further comprising a memory for storing a look-up table, wherein the control unit is for determining the first turn-on time length according to the gray level value of at least a pixel of the first display block and the look-up table, and for determining the second turn-on time length according to the gray level value of at least a pixel of the second display block and the look-up table.
